(19) United States
(12) Patent Application Publication
(10) Pub. No.: US 2019/0377248 A1
(43) Pub. Date: Dec. 12, 2019

(54) METHOD AND APPARATUS FOR DYNAMICALLY VARIABLE ELECTRICAL CONTROL OF LIGHT BEAM REFLECTIVE LIQUID CRYSTAL DEVICES

(71) Applicant: UNIVERSITÉ LAVAL, Quebec (CA)

(72) Inventor: Tigran GALSTIAN, Quebec (CA)

(21) Appl. No.: 16/463,198

(22) PCT Filed: Dec. 14, 2017
(86) PCT No.: PCT/CA2017/051518

§ 371 Date: May 22, 2019

Related U.S. Application Data
(60) Provisional application No. 62/433,928, filed on Dec. 14, 2016.

(51) Int. Cl. G03B 21/00; G02F 1/1334; G02F 1/1335; G03B 21/28; G03B 21/20; H04N 9/31

(52) U.S. Cl. CPC G03B 21/006; G02F 1/1334; H04N 9/3102; G03B 21/28; G03B 21/2033; G02F 1/133553

(57) ABSTRACT

A variable reflection mode optical device for controlling properties of reflected light is described. The device includes a light reflecting surface of an array of controllable mirror elements, a layer of dynamically controllable material and an excitation source for generating an excitation field acting on the layer of dynamically controllable material. An electrical drive signal applied to the excitation source causes a change of optical properties in the layer of dynamically controllable material to provide a spatially varying change in light reflection having at least one of a desired phase curvature and a desired amplitude modulation profile.

This application claims priority of U.S. provisional patent application 62/433,928 filed Dec. 14, 2016, the content of which is hereby incorporated by reference.

### TECHNICAL FIELD

The proposed solution relates to the field of reflective electrically controllable light beam optical devices. More particularly, the proposed solution is directed to a method and apparatus for dynamically variable electrical control of reflection of a light beam using liquid crystal materials.

### BACKGROUND

In many photonic applications, control of the divergence of light beams is required. As is known, light properties may be changed in both transmission mode and reflection mode, the latter being particularly important in applications such as stabilized holographic systems, image acquisition, lasing, lighting, etc.

Legacy solutions are mostly based on mechanical movement of the position of a mirror (for example, using a piezo element) or on mechanical variation of the curvature of the mirror (bending, torsion, etc.)

Several approaches have been explored whereby, instead of mechanically moving a mirror, the curvature of the mirror is changed. With reference to FIG. 1, one prior art solution uses multiple Micro-Electro-Mechanical-Systems (MEMS) elements 111 spread over a surface of a reflecting device 1, providing variable surface curvature light reflection. As shown, an incident light beam 2 having a flat incident phase plane 3 and incidence angle 6, measured with respect to mirror normal 5, is reflected by reflective device 1. The reflected beam 4 is characterized by a curved reflected phase plane 7. In this case, the position of each mirror element 111 must be changed to change the optical parameters of the overall system 1. Unfortunately, this mechanical movement is problematic to the overall functionality of the system in terms of vibration, motion settling time, backlash, etc. and has limited applications.

Other mechanical solutions have also been proposed, such as the use of a deformable membrane, for example. This solution is also based on mechanical movement, which is less than ideal.

However, motion-less (or motion-free) solutions have advantages making them more appealing.

Motion-free electrically controlled uniform reflection is known and largely used in Liquid Crystal Display (LCD) technologies such as described by L. M. Blinov, V. G. Chigrinov in “Electro-optic effects in Liquid Crystal Materials”, Springer-Verlag, N.Y., 459 pp, 1994. FIG. 2 shows an example of a prior art electrically controllable reflection LCD pixel. Each reflective LCD pixel (or unit) includes a layer of dynamically controllable material 8 which is uniform (for example, liquid crystal or polymer composite), as well a fixed mirror 9 of high reflectivity which is also uniform. One important differentiating aspect of such a dynamically variable mirror is the uniform character of reflection of each LCD pixel. That is, the wavefront curvature (or intensity profile) of the reflected light from each pixel is not modulated across the given pixel. Modulation may only be achieved over the greater LCD panel using different voltages applied to multiple pixels individually. In some applications this again introduces spatially discontinuous operation leading to granularity of operation problems, is costly to manufacture and increases control complexity at least in the sense that separate control is required for each pixel.

Light beam shaping devices are known in the prior art. Majority of light beam focusing devices operate in the transmission mode which imposes high optical quality requirements on a large number of successive substrates (including input and output beam substrates and transparent electrodes). This in turns imposes restrictions on the type of substrates and electrodes to be used for dynamic variable control.

For example, prior art beam focusing reflective solution uses multiple (more than two) transparent electrodes, such as Indium Tin Oxide (ITO), on a Liquid Crystal (LC) cell substrate as described by S. T. Kowel, P. G. Kornreich, D.S. Cleverly in “Adaptive liquid crystal lens”, U.S. Pat. No. 4,572,616, 1986 (filed August 1982) and by N. A. Riza, M. C. DeJule in “Three-terminal adaptive nematic liquid-crystal lens device”, Opt. Lett. 19, pp. 1013-1015, 1994. Although motion-free, such prior art attempts are still limited because of spatially discontinuous operation (granularity) and control complexity (separate drive for each one of the multiple electrodes).

As generally used herein, “pixilated” characteristics reference independently controlled elements in/of devices requiring individual electrical control employing complex control components and complex control trace lithography. Such complexity increases manufacturing cost and suffer from low manufacturing yields. Unfortunately, all of these prior art solutions have performance and/or manufacturing problems, due in part to the fact that the solutions were originally designed for operation in transmission mode only.

Other transmission mode beam focusing devices have been proposed by the inventors as described in International Application WO 2015/103709, however their adaptation to reflection mode beam shaping and/or steering devices has remained a challenge. See the article by T. Galstian, K. Allahverdyan, Focusing unpolarized light with a single nematic liquid crystal layer, Optical Engineering, Vol. 54(2), pp. 025104:1-5, 2015.

Reflective type tunable optical beam focusing devices have been proposed by the applicant in International Patent Application WO 2015/103709, published Jul. 116, 2015. Such achievements are limited to single aperture optical elements, such as lenses and tunable focusing mirrors. With reference to FIG. 3, the majority of such liquid crystal elements include gradient index structures 8, the corresponding single aperture elements are limited to small diameter devices, typically from 0.5 mm to 5 mm where the optical power (degree of control) is inversely proportional to the square of the optical diameter. However the use of two (or one) electrodes (instead of multiple) significantly reduces the cost and complexity of the device.

Recent market forces have brought about new emerging applications where the light beam of large diameter LED light sources (with diameters ranging from 20 mm to 120 mm) must be dynamically controlled. Multi aperture transmission mode LC beam control elements can be used in such cases, for example as described by the inventors in International Application PCT/CA2016/050589 having a priority date of Sep. 12, 2015. See the article by T. Galstian, K. Allahverdyan, Focusing unpolarized light with a single nematic liquid crystal layer, Optical Engineering, Vol. 54(2), pp. 025104:1-5, 2015. As generally used herein, “multi-aperture devices” include massive arrays of periodic or non-periodic beam control elements concurrently driven via a limited number of electrical connections for the entire massive array.

While such transmission mode multi aperture LC beam control arrays can be used successfully in some lighting application implementations, in other implementations the form factor of LED light source components limits the LC beam control provided in a luminaire. For example, individual LED components have a Lambertian source light output beam distribution which has an intensity drop-off measured in terms of solid angle spread about the normal axis, referred to as Full

Width Half Maximum (FWHM) intensity, which limits the combined aperture of transmission mode multi aperture LC beam control arrays employed in a simple luminaire. The remainder of the LED light beam power is lost as stray light with the luminaire operating at less than desirable power efficiency. In order for some lighting effects to be achieved, the stray light needs to be blocked or absorbed (and therefore lost to heat).

### SUMMARY

In contrast with prior art attempts, embodiments of the proposed solution include reflective multi aperture LC beam control devices which can be used to dynamically control a higher fraction of the incident LED source light beam with reduced restrictions on the form factor of the LED source components employed. This allows the use of very cost effective approaches to obtain the desired beam shaping, for example allowing higher admission angles.

In some implementations, proposed devices are made by using flexible substrates allowing the fabrication of deformable or bent non-planar beam control structures which can be employed with complex curved reflective structures.

The proposed solution provides methods and apparatus for electrically controlling a dynamically variable optical reflective device using non-uniform excitation instead of using multiple pixel separately controlled elements. In a specific example, a spatially non-uniform excitation field, which can be for example an electric field, is generated by two electrodes and is used to control the optical properties such as index of refraction or absorption of a layer of dynamically controllable material, such as a nematic liquid crystal layer, within the overall optical reflective device.

The multi aperture reflection mode LC beam control devices of the proposed solution, in accordance with various embodiments, preferably includes LC cells employing:
various liquid crystal mixtures in their various possible phases (states), including nematic, chiral uniform or non uniform, blue phase, PDLC, PSLC, containing nano particles or other dopants, etc.—various liquid crystal ground state alignment layer orientations without restrictions: such as in-plane alignment (X, Y, 45°, intermediate angles, etc.) and homeotropic (substantially parallel to normal axis Z) for example as described by the inventors in International Application PCT/CA2016/050589 having a priority date of Sep. 12, 2015;
various alignment layer pattern configurations, such as varying in space (monotonic), circular, radial, periodic, with spatially varying period, aperiodic, random, etc.;
wherein the various alignment orientations and configurations can be provided employing traditional (e.g., rubbing, tilted deposition, etc.) or advanced dynamic methods for example as described by the inventors in International Application WO 2010/006420 published Jan. 21, 2010 and in U.S. Pat. No. 7,218,375.

At least one substrate, sandwiching at least one LC layer, used in various implementations of the proposed multi aperture reflection mode LC beam control device units includes at least one control electrode thereon. With reference to description by the inventors in International Application PCT/CA2016/050589 having a priority date of Sep. 12, 2015, electrodes can, without limiting the invention, include at least one of: uniform layer electrodes, parallel electrodes (fingers), interdigitated electrodes, circular, radial, periodic, aperiodic, with spatially varying spacing (chirping), with spatially varying width, with spatially varying orientation, sparsely connected, randomly perforated, etc. Combinations of such electrodes on a substrate can be electrically separated by employing isolation layer, electrically coupled (resistive layer, bipolar gels, etc.), capacitively coupled (weakly conductive layer), etc. to provide a desired electric field profile within the adjacent LC material layer.

Typically, for transmission mode dynamically variable liquid crystal light shaping devices, at least two LC cells are required in the beam path to control two perpendicular polarization modes (in two perpendicular planes or directions). For example, if electrodes (connected or interdigitated) parallel to Y-axis are employed, then usually, the light polarization that is parallel to X-axis is dynamically controlled. The focusing of that polarization component (convergence) and its further broadening (divergence) will be mainly in the XZ plane. Controlling the same polarization (II Y) in the perpendicular YZ plane requires an additional LC layer (with electrodes that are parallel to X axis) or to somehow rotate that light polarization at 90° within the same LC cell and then pass that light beam through another slice (of the same layer) of LC cell controlled by electrodes that are parallel to the X-axis. However, in preferred implementations, controlling both polarizations simultaneously is required for unpolarised light (broadening/steering in two planes). This requires at least another LC cell with its optical axis rotated at 90° with respect to the first. However, the inventors have found a way to do it in a single homeotropic cell (in-side cell polarization rotation) for example as described by the inventors in International Application PCT/CA2016/050589 having a priority date of Sep. 12, 2015.

In accordance with the proposed solution, the introduction of reflection mode geometries eliminates the need for two LC cells.

Preferably LC cells employed in accordance with the proposed solution are uniformly made in the sense that LC cells have uniform overall thickness between support substrates. However, LC layers of the proposed solution can be non-uniform throughout, without limiting the invention, including locally non-uniform polymer or other content therein, as well as walls separating various subsections of LC material, etc. For example, the LC material used in the proposed LC layers can be: pure or doped (for example as described by the inventors in International Application WO 2009/153764 published Jan. 21, 2010), dispersed, polymer stabilized (for example as described by the inventors in International Application WO 2010/006420 published Jan. 21, 2010) or polymer dispersed (for example as described by the inventors in U.S. Pat. No. 7,218,375) or other type that responds to an external stimuli. The type of the base LC material may be nematic, cholesteric, smectric, blue phase, etc. (for example as described by the inventors in U.S. Pat. No. 8,252,201)

In accordance with various implementations of the proposed solution, such control electrodes are supplied with drive signals using different electric signals with various amplitudes, frequencies, relative phases, pulses, overdrives, underdrives, etc. for example as described by the inventors in U.S. Pat. No. 9,030,595 and in U.S. Pat. No. 9,405,093.

The use of such an electrically controlled variable optical reflective device to generate electro-optical tuning/control of reflection phase and amplitude with low losses and a simpler construction and/or manufacture are also described herein.

The proposed solution also provides a method and apparatus for electrically controlling a variable optical reflective device using non-pixellated planar (standard) LC cells or composite polymer films, for example located on a surface of a total internal reflection element.

### BRIEF DESCRIPTION OF THE DRAWINGS

The invention can be better understood by way of the following detailed description of embodiments of the proposed solution with reference to the appended drawings, in which:

FIG. 1 is a schematic representation of a prior art curved tunable mirror using MEMS elements and its reflection properties;

FIG. 2 is a schematic representation of a prior art configuration of a dynamically variable uniform mirror used in traditional reflective LCDs using individual control for each of multiple individual pixels;

FIG. 3 is a schematic representation of a dynamically variable and spatially non-uniform single-aperture mirror configuration using a uniform excitation source and non-uniformly controlled material according to a prior art implementation;

FIG. 4 is a schematic representation, in an exploded isometric view, of a dynamically variable and spatially non-uniform multi-aperture mirror element configuration using a controllable LC material layer and non-uniform excitation according to a non-limiting implementation of the proposed solution;

FIGS. 5A and 5B schematically respectively represent geometries of spatially non-uniform liquid crystal mirror element employing a polarization transformer according to a non-limiting embodiment of the proposed solution;

FIG. 5C is a schematic diagram illustrating the principle of operation of a polarization transformer in liquid crystal mirror element geometries illustrated in FIGS. 5A and 5B;

FIG. 6 is a schematic representation of a polarization-independent mirror element using two cross-oriented electrode patterns within a single LC layer according to a non-limiting embodiment of the proposed solution;

FIGS. 7A, 7B and 7C schematic representations of orthogonally oriented electrode arrays for use with arrays of reflection mode dynamic LC controllable mirror elements according to non-limiting implementation of the proposed solution;

FIG. 8A is a schematic representation of a polarization-independent mirror unit element using a non-uniform LC control microstructure according to a non-limiting embodiment of the proposed solution;

FIG. 8B is a schematic representation of an implementation detail of the dynamically variable LC reflective control devices illustrated in FIG. 8A in accordance with the proposed solution;

FIG. 8C is a schematic representation of an implementation detail of the dynamically variable LC reflective control devices illustrated in FIG. 8A in accordance with the proposed solution;

FIG. 9 is a schematic representation of a polarization-dependent mirror element using a holographic mirror element according to a non-limiting embodiment of the proposed solution;

FIG. 10 is schematic representation of a polarization-independent LC mirror element using a holographic front element to provide controllable light beam steering according to a non-limiting embodiment of the proposed solution;

FIG. 11A is a plan view illustrating an implementation of an array of reflective dynamic LC mirror elements in accordance with various embodiments of the proposed solution;

FIG. 11B is a schematic diagram illustrating the array of reflective dynamic LC mirror elements illustrated in FIG. 11A bent into a cylinder in accordance with various embodiments of the proposed solution;

FIG. 12 is a schematic diagram illustrating an array of reflective dynamic LC mirror elements similar to the one illustrated in FIG. 11A bent into a cone section in accordance with various embodiments of the proposed solution;

FIG. 13A to 13C schematically illustrate three variant assemblies of the reflecting dynamic LC controllable mirror arrays, according to non-limiting implementations of the proposed solution;

FIG. 14 schematically illustrates a layered structure of the reflection mode LC controllable elements in which significant portions of the electrically controllable structure is located behind the reflective component in accordance with various embodiments of the proposed solution;

FIG. 15 schematically illustrates a polarization-independent layered structure of the reflection mode LC controllable elements employing a pair of LC layers having orthogonally oriented alignment layers;

FIG. 16 schematically illustrates LC controllable light beam steering using controllable LC mirror elements in arrays 11 in accordance with the proposed solution;

FIG. 17 schematically illustrates a solar concentrator employing reflection mode LC controllable devices in accordance with the proposed solution;

FIGS. 18A and 18B schematically illustrate implementations of reflection mode LC light beam control arrangements employing waveguides in accordance with some implementations of embodiments of the proposed solution,

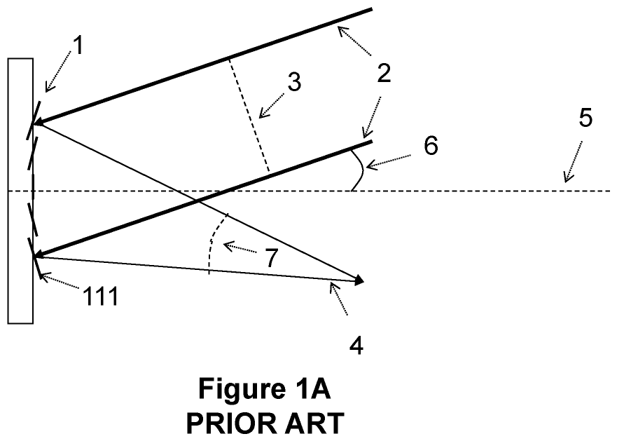

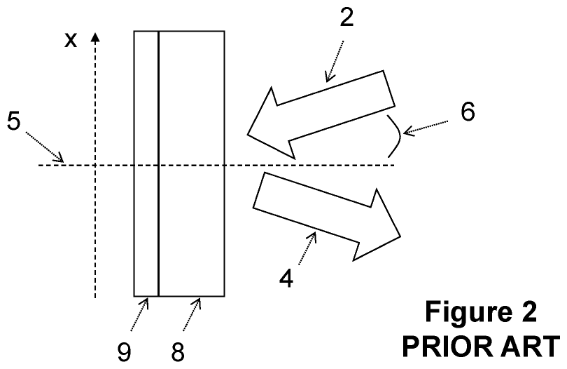

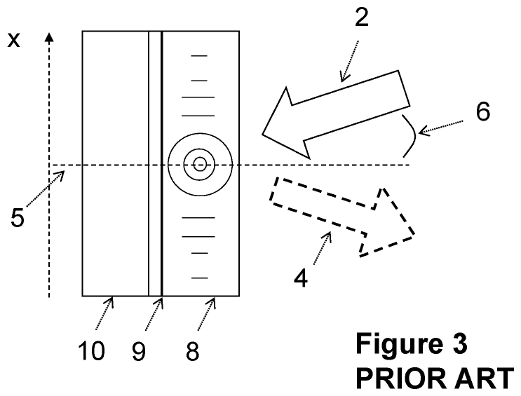

wherein same labels refer to similar features throughout the figures. While the layer sequence described is of significance, reference to “front” and “back” qualifiers in the present specification is made solely with reference to the orientation of the drawings as presented in the application and do not imply any absolute spatial orientation.

### DETAILED DESCRIPTION

In contrast with the above-discussed prior art solutions, which have been designed for operation in transmission mode only, reflection mode electrically controllable devices are described in accordance with the proposed solution which is directed to reducing light flux loss and reduced cost of a variable optical reflective spatially continuous (non-pixellated) device which is electrically controllable using an electric field and a controllable material layer, such as liquid crystal or composite polymers cells. Such a device can be used for controllable reflection to provide beam control, beam dispersion, steering, scattering, etc.

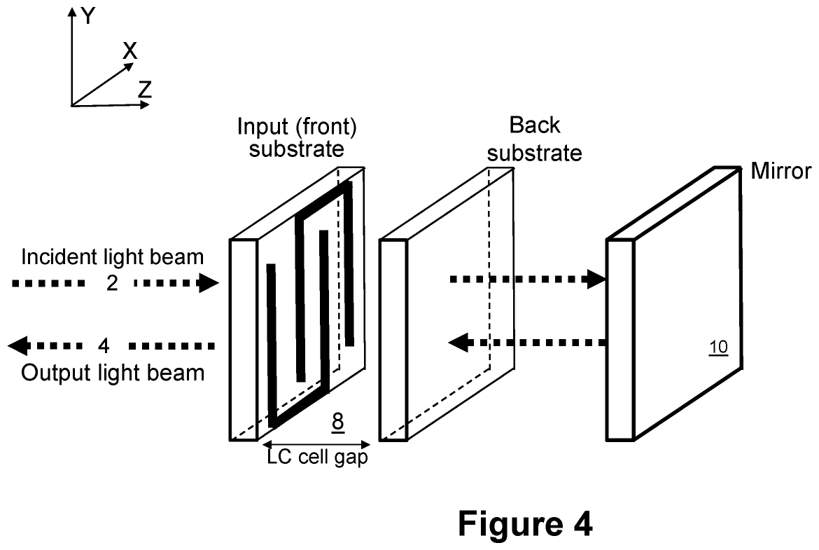

In accordance with a first embodiment of the proposed solution, various combinations of substrates with different electrode configurations, LC materials and LC ground state alignments can be used for both, input and back, substrates. In accordance with the proposed solution, multiple beam control elements such as illustrated in FIG. 4 are employed in the XY plane to build and provide large optical aperture devices.

In accordance with the proposed solution, a mirror 10 can be added to the control unit element illustrated in FIG. 4. Mirror 10 can be dielectric or metallic (integrated to the LC cell, attached to the back substrate or adjusted behind, for example as a reflector of an LED light source; including planar or curved mirrors). All optical interfaces can include index matching layers (not shown) to reduce undesired losses if needed. For clarity, FIG. 4 is schematic; the separation of the LC cell gap between the front and back substrates is physical to contain the LC material layer 8, while the separation between the back substrate and the mirror 10 may not be physical for a mirror 10 integrated into the back substrate or manufactured on the back substrate.

Some implementations of this first embodiment provide enhanced light beam modulation provided by a double-passage of the light beam through the single LC cell, including a reduction in the required thickness of the LC cell gap.

Other implementations of this first embodiment employing an integrated dielectric mirror, described by the inventors in International Application WO 2015/103709, can provide freedom of use various patterned electrodes (including non-transparent ones) integrated behind the mirror 10. In such implementations, both the mirror 10 and the electrodes of the second substrate can be integrated (created) on the inner surface of the back substrate to reduce the required operation voltages and to improve the electric field profile inside the LC cell 8.

Combination of multiple layers of electrodes may be accomplished (in another embodiment) by simply using a metal (conductive) reflector that simultaneously serves as a uniform back electrode. This metal may be covered by a dielectric reflective layer (serving at the same time also as an electrical isolator) and then covered by a patterned transparent electrode, providing thus an enhanced control over the shape of the electric field.

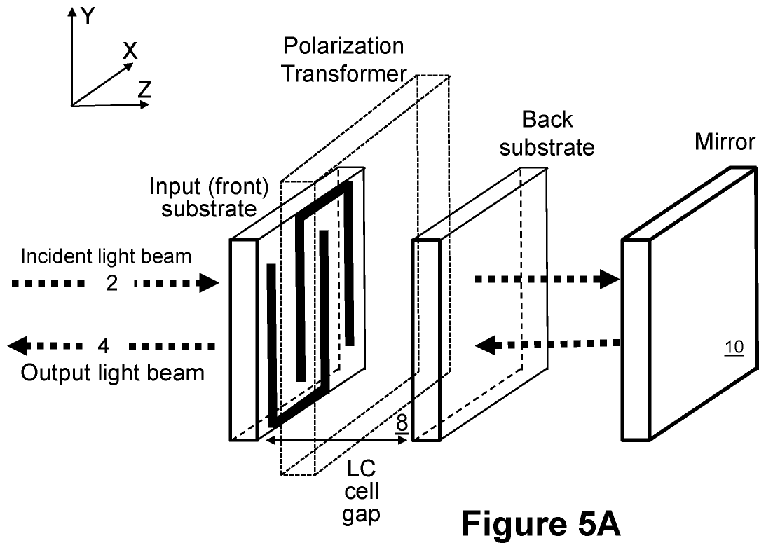

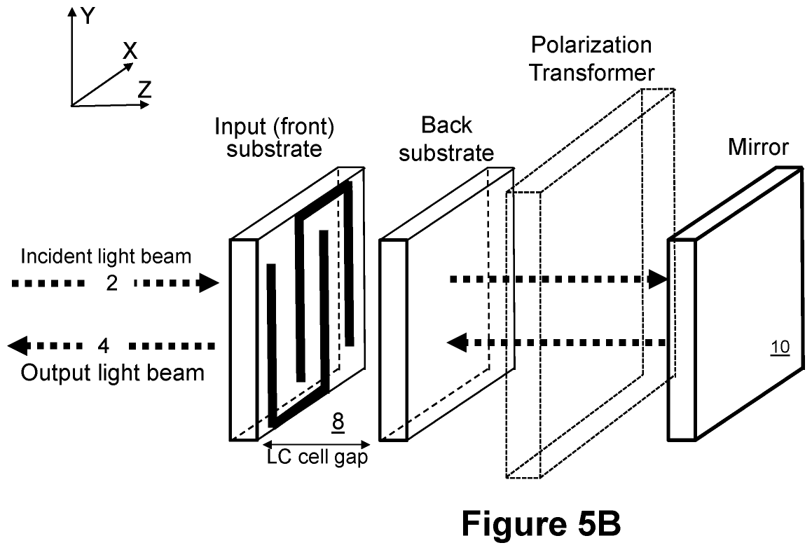

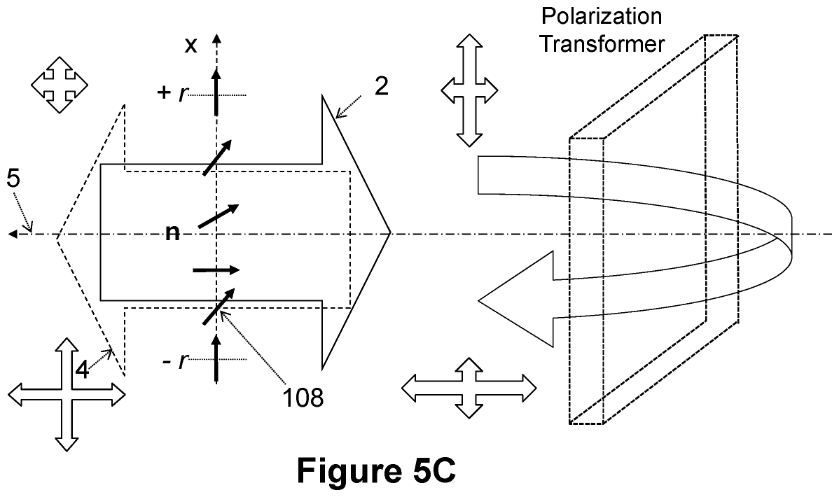

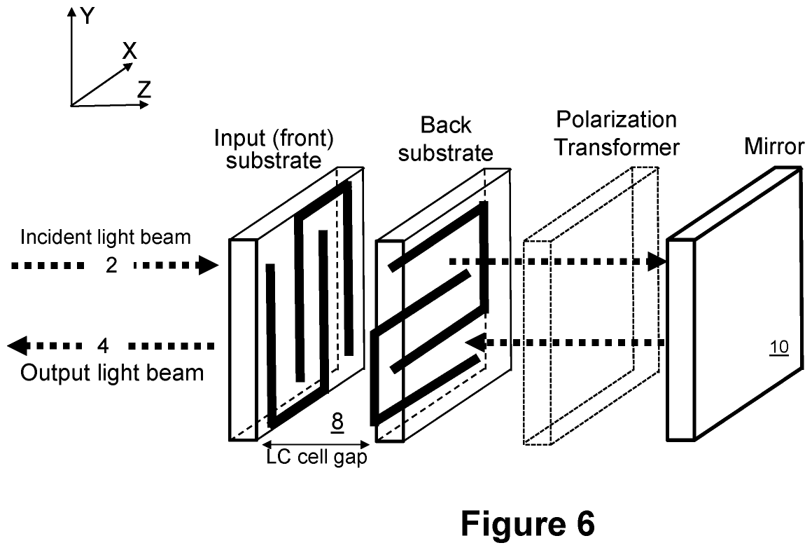

In accordance with a second embodiment of the proposed solution, various combinations of substrates with different electrode configurations, LC materials and LC ground state alignments can be used for both, input and back, substrates. In accordance with the proposed solution, multiple beam control elements such as illustrated in FIGS. 5A and 5B are employed in the XY plane to build and provide large optical aperture devices.

In accordance with the proposed solution, a stationary or dynamic polarization transformer can be added. The polarization transformer can be a broad band polarization rotator (passive, e.g., based on anisotropic films or active, e.g., based on twisted nematic LC films, etc.) or depolarizer. The polarization transformer can be integrated into the LC cell as schematically illustrated in FIG. 5A or added to the LC cell separately as illustrated in FIG. 5B.

Some implementations of this second embodiment provide the modulation (broadening, steering, etc.) of both (X and Y) polarization components of unpolarized light in the XZ plane provided by double-passage of the polarization rotated light beam through the LC controllable layer as schematically illustrated in FIG. 5C. Heavy arrows 108 illustrate a spatially variable LC molecular director orientation (in the XZ plane) in the LC material layer 8 along the X axis which controls an optical property of the corresponding light beam polarization.

While the multi-aperture character of the device may be achieved by using uniform electrodes and non-uniform LC layers (containing orientation defects, polymer or nano particle inclusions, etc.), the light modulation can be also achieved by using uniform LC cells. Thus, in accordance with a third embodiment of the proposed solution, mutually orthogonal electrode patterns are employed on opposing substrates of the same LC cell with various combinations of LC materials and LC ground state alignments for both, input and back, substrates. In accordance with the proposed solution, the polarization transformer can be a broad band polarization rotator (passive, e.g., based on anisotropic films or active, e.g., based on twisted nematic LC films, etc.) or depolarizer.

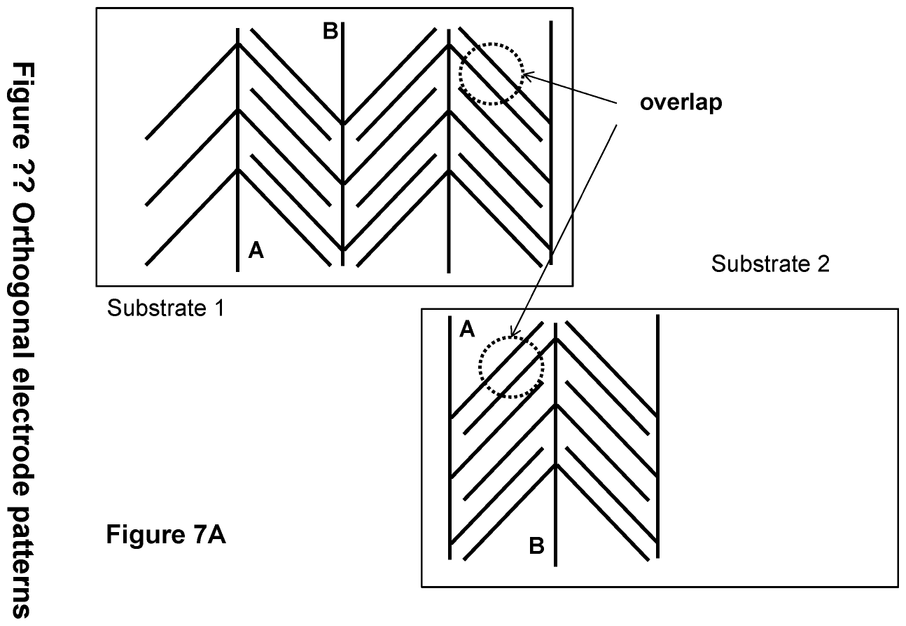

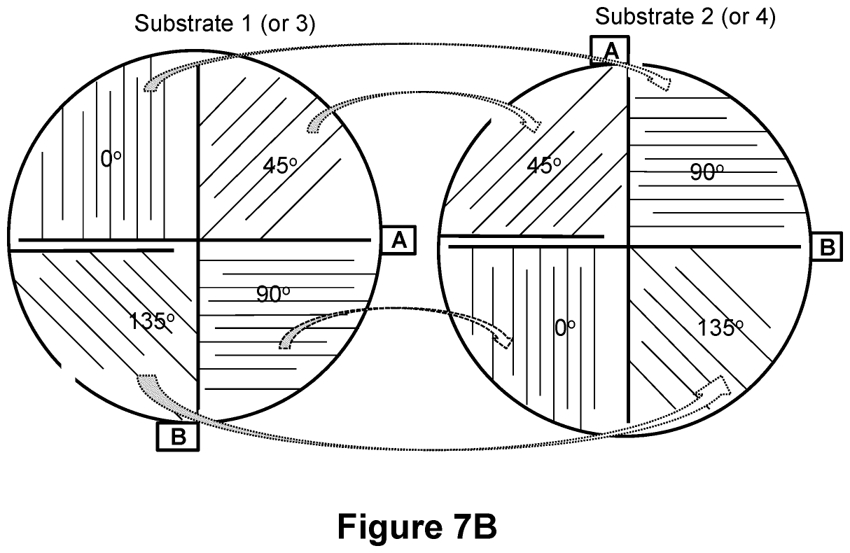

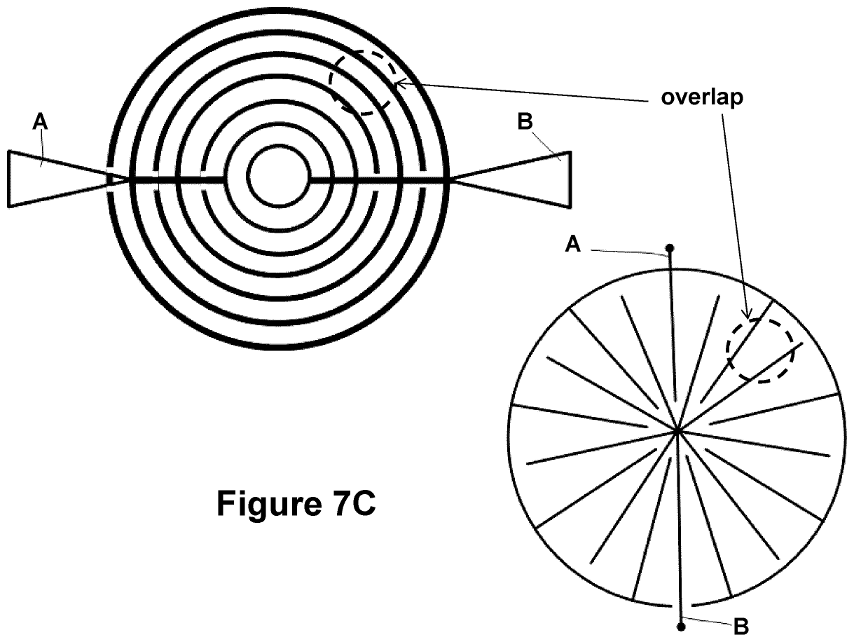

FIGS. 7A, 7B and 7C are illustrative of orthogonal electrode arrays for arrays 11 of reflection mode dynamic LC controllable devices in accordance with two implementations of the proposed solution.

Implementations of this third embodiment provide modulation of both polarization components of the light beam in both planes (XZ and YZ) provided by the polarization rotation inside the LC cell itself and also provided by the external polarization transformer during the double-passage of the light beam through the layer geometry. In operation, the amount of polarization rotation imparted to the light beam can be controlled through independent activation of electrodes while also enabling independent or simultaneous control of both polarizations.

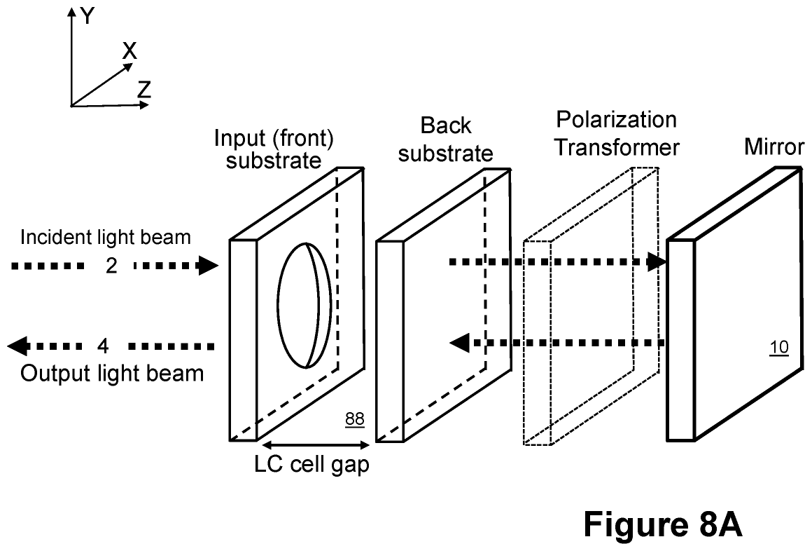

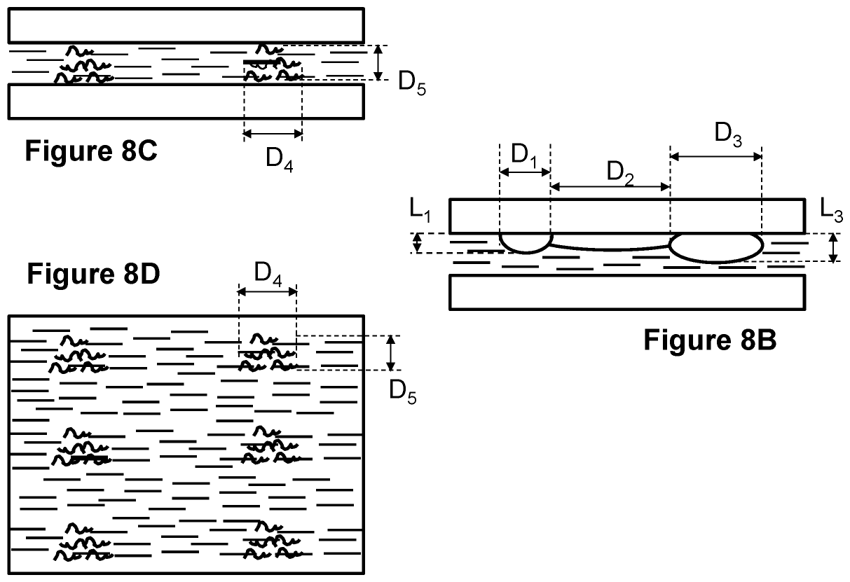

In accordance with a fourth embodiment of the proposed solution, schematically illustrated in FIG. 8A, each dynamic LC optical element includes a spatially non-uniform LC layer, without limiting the invention, one of: a non-uniform LC cell gap 88, a micro lens, a prism-like microstructure and a non-uniform polymer network dispersed within the LC layer. In accordance with the proposed solution, uniform electrodes and/or various electrode patterns are employed on both opposing, input and back, substrates with various combinations of LC materials and LC ground state alignments. In accordance with the proposed solution, the mirror element can be a dielectric mirror or metallic.

Implementations employing a dielectric mirror provide freedom of using various patterned electrodes (including non-transparent ones) integrated behind the dielectric mirror 10 front reflecting surface. In such implementations, both the mirror 10 and the electrodes can be integrated on the inner surface of the back substrate to reduce the required operation voltages and to improve the electric field profile inside the LC cell 8/88.

Implementations employing a metallic mirror, the metallic mirror can be attached to the back substrate or adjusted behind, for example as a reflector of an

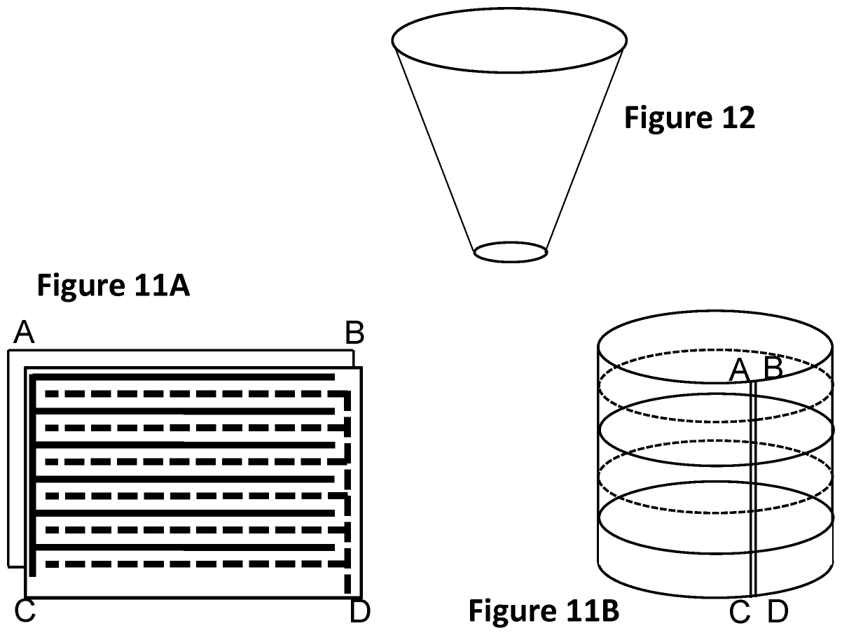

LED light source. The metallic mirror includes curved mirrors, see FIGS. 11B, 12, 13A, 13B and 13C.

Implementations employing a polarization transformer can include a broad band polarization rotator (passive, e.g., based on anisotropic films or active, e.g., based on twisted nematic LC films, etc.) or a depolarizer. Such implementations of this fourth embodiment provide modulation of both polarization components of the light beam in both planes (XZ and YZ) provided by the polarization rotation inside the LC cell itself and also provided by the external polarization transformer during the double-passage of the light beam through the layer geometry.

In accordance with another embodiment of the proposed solution, schematically illustrated in FIG. 8B, 8C, and 8D, the LC cell may include a spatially non-uniform LC layer (containing orientation defects, polymer or nano particle inclusions, chiral structural defects, substrate non-uniformities, etc.). In this case, the multi-aperture character of the device may be achieved by even using uniform electrodes.

FIG. 8B illustrates a fourth embodiment implementation example of the non-uniform LC layer having a uniform LC cell gap 8 between flat substrates. One of the substrates, besides electrode(s) and alignment layers, has formed thereon non-uniform microstructures, preferably transparent but not necessarily, having, preferably but not necessarily random, characteristic dimensions Dx and Lx in the transverse and axial directions. In accordance with a non-limiting implementation of this fourth embodiment of the proposed solution, the microstructures are formed by droplet deposition employing a spray nozzle and then cured. The cured droplets can have a transverse size variation D1 to D3 with a selected characteristic distribution, and a cured droplet axial size (thickness) L1 to L3 with a selected characteristic distribution. The cured droplets can have a different index of refraction than the surrounding LC material. Characteristic operational parameters include:

Vₜₕ=LE=π[K/(ε₀Δε)]^{0.5} and V_{LC}=V/[1+(ε_{LC}/εₚ)(Lₚ/L_{LC})

FIGS. 8C and 8D illustrate other fourth embodiment implementation examples of the non-uniform LC layer having a uniform LC cell gap 8 between flat substrates. FIG. 8C illustrates one dimensional polymer stabilized structures, while FIG. 8D illustrates two dimensional polymer stabilized structures. While the LC material layer is of uniform thickness (gap 8) sandwiched between parallel support substrates, the initial LC mixture can doped with uncured polymers which can be subsequently cured to form, preferably random, clumps characterized by dimensions D4 and D5. In a specific implementation, lens like or prism-like microstructures can be provided by employing photo polymerizable LC material dopants. Characteristic operational parameters include:

Vₜₕ=LE=π[K_{eff}/(ε₀

Δε_{eff})]^{0.5}

In accordance with such implementations uniform cost effective electrodes can be used to provide a spatially non-uniform LC reflection control.

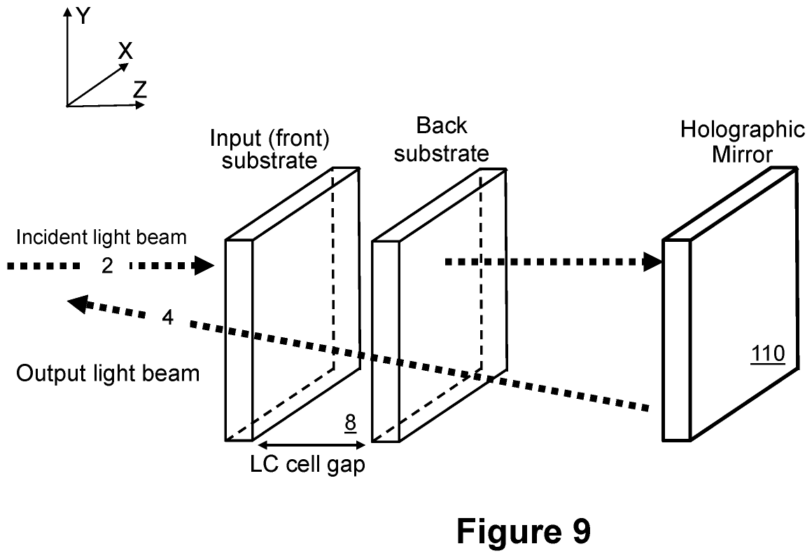

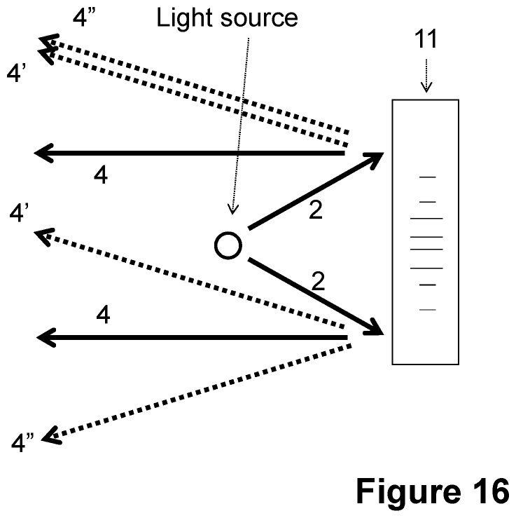

In accordance with a fifth embodiment of the proposed solution schematically illustrated in FIG. 9, the mirror 10 element can be implemented in a pre-recorded holographic reflector 110 which can extend over the entire array of mirror elements 10. The pre-recording can include large angular deviations of the reflected light, each angle of reflection being programmed (matched) for given types of phase front deformations introduced by the passage of light through the LC cell (illustrated from left to right, in FIG. 9). Without limiting the invention thereto, such pre-recording enables large angle variable beam steering for a single light beam polarization component 11 illustrated in FIG. 16. Various combinations of substrates with different electrode configurations, LC materials and LC ground state alignments can be used for both, input and back, substrates. The diffractive or holographic element is included to enhance the steering or broadening as well as to perform other predetermined (recorded in the diffractive/holographic element) functions.

In another implementation (not shown) an additional LC cell can be used, between the illustrated LC cell and the holographic mirror 110 to enable modulation of two orthogonal (perpendicular) polarizations of the incident light beam. Such an arrangement provides controllable light beam steering of both polarization components of light in both orthogonal planes XZ and YZ (FIG. 16).

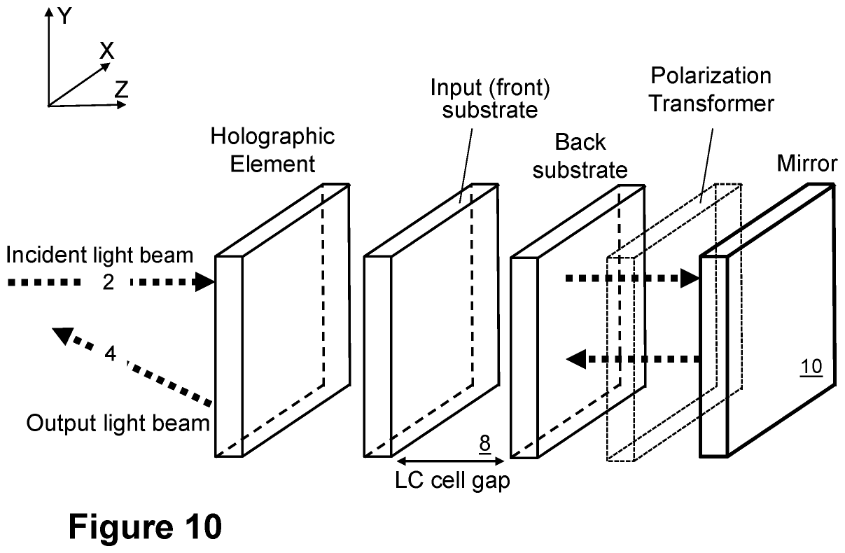

In accordance with a sixth embodiment of the proposed solution schematically illustrated in FIG. 10, hologram element can be used as the front surface of the controllable reflection element to generate large angular deviations of the reflected light beam (FIG. 16). In accordance with some implementations the hologram element is pre-recorded, in accordance with other implementations the hologram element is recorded in-situ, each angle of deviation being programmed (matched) for given types of phase front deformations introduced by the double passage of light through the LC cell enabling large angle variable light beam steering. Various combinations of substrates with different electrode configurations, LC materials and LC ground state alignments can be used for both, input and back, substrates.

Depending on implementation of the sixth embodiment, mirror 10 can be dielectric or metallic (integrated to the LC cell, attached to the back substrate or adjusted behind, for example as a reflector of an LED light source; including planar or curved mirrors).

Depending on implementation of the sixth embodiment, the polarization transformer can be a broad band polarization rotator (passive, e.g., based on anisotropic films or active, e.g., based on twisted nematic LC films, etc.) or depolarizer.

While specific reference was made to the manufacture and principle of operation of each reflection mode LC controllable mirror element in each above described embodiments, such device arrays can be fabricated on flexible or bendable substrates. FIGS. 11A illustrate an array of such reflection dynamically controllable LC mirrors manufactured flat on a flexible substrate which is bent into a cylinder as illustrated in FIG. 11B for integration into various LED luminaires. In some implementations the back plane (A-B) can contain a reflector or a reflector of the LED module may be used (see hereinbelow). FIG. 12 illustrates such a flexible LC mirror array structure bent into a conical section to be integrated into a luminaire. Notably, the entire array is controlled via two electrodes.

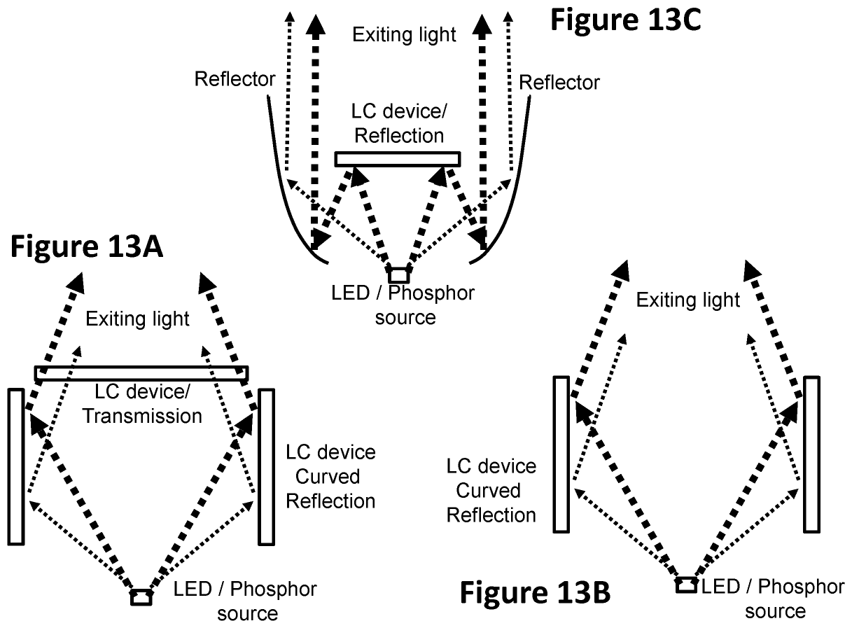

The above embodiments can be implemented in various LED existing luminaires of various forms for example illustrated in FIGS. 13A, 13B and 13C. FIG. 13A illustrates an implementation wherein the reflective dynamic LC controllable devices are employed in a non-exclusively combined with a transmissive dynamic control device(s). While FIG. 13B illustrates a cylindrical implementation, it is understood that the reflective dynamically controllable LC element arrays can be implemented in elliptical reflectors. FIG. 13C illustrates the use of multiple reflections in the light beam path to controllably achieve different lighting effects.

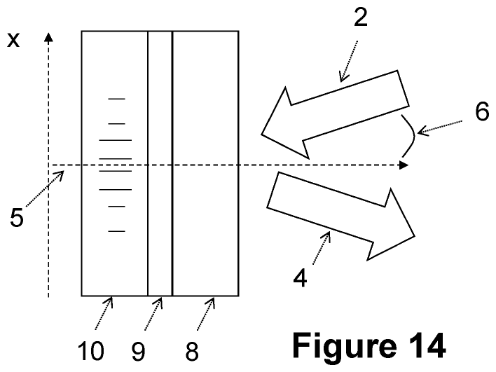

Employing a reflection geometry allows the use of a much broader range of: electrodes (including optically non-transparent) at least some of which improve control ability and significantly facilitate manufacture thereof while reducing cost. Improved performance and manufacturing advantages with respect to the known prior art electrically controllable reflection devices can be achieved. For example, in some implementations described herein and illustrated very schematically in FIG. 14, the light path does not traverse some electrode layers 9, which improves both the transmission (output) and high-power resistance (reliability) of such devices. By placing a control electrode structure behind the reflective surface of the mirror element 10, a greater choice of electrodes, electrode forms, and electrode material compositions are available which can reduce manufacturing constraints.

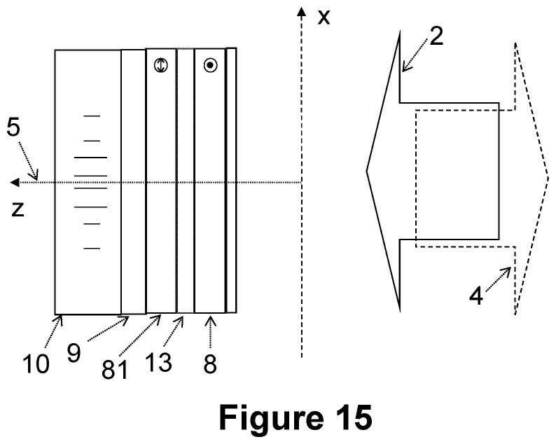

While some of the illustrated implementations of some of the embodiments only apply to polarization-dependent light beams, it is emphasized that such figures are intended to simplify illustration of the principles of operation of such devices. FIG. 15 illustrates details of polarization-independent layered geometries employing a pair of LC layers 8 and 81 (with a separating substrate 13) having orthogonally oriented alignment layers in accordance with various embodiments of the proposed solution.

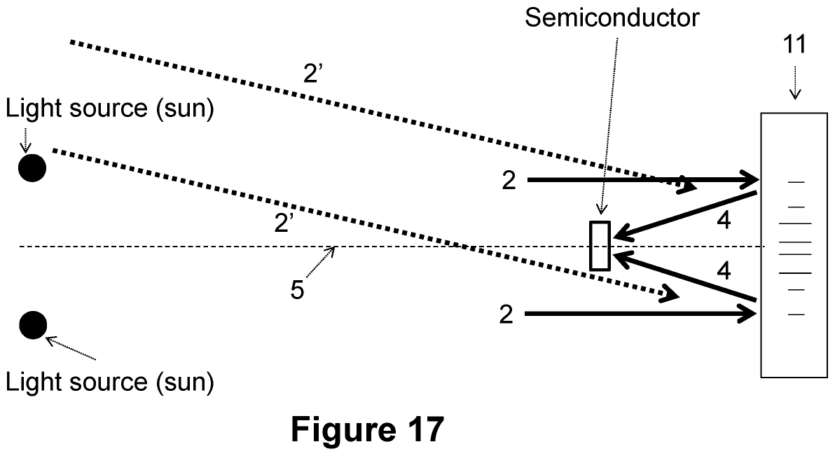

It should also be appreciated by the reader that various optical devices can be developed using one or more combinations of devices described above. For example, with reference to FIG. 17, if the LED source is replaced by a photodetector, various devices can be implemented including a light source tracking device, for example an angular tracking device for solar concentrators. Controllable mirror array 11 can be used to optimize the operation and cost of photovoltaic solar concentrators combining reflective focusing and steering functions.

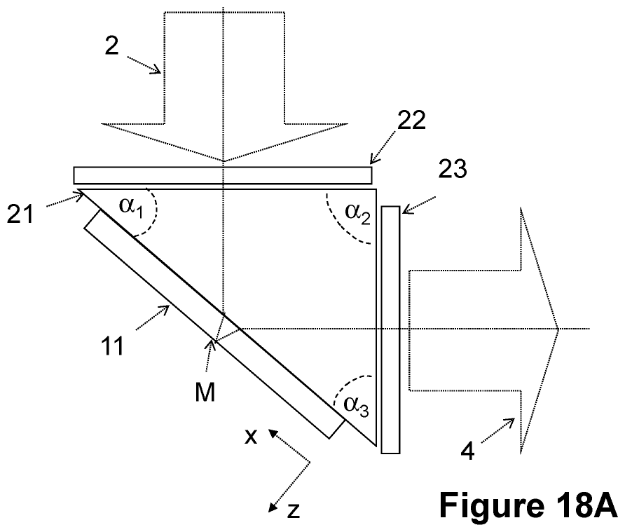

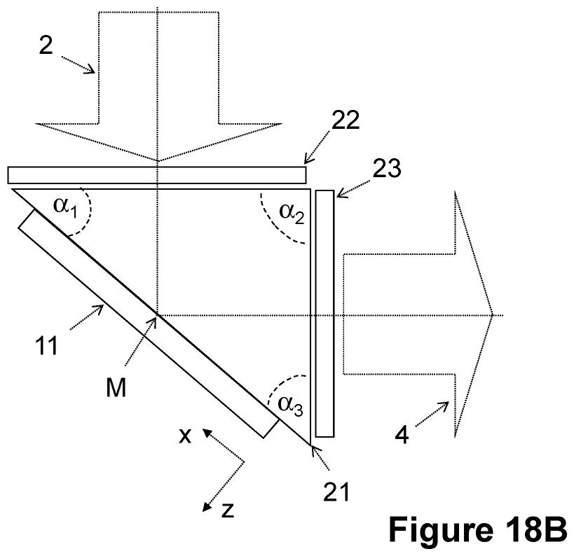

Without limiting the invention, applications such as illustrated in FIG. 13A can be extended to include an optical wave guide 21 wherein reflection mode arrays of controllable LC mirror elements 11 can be used to control total internal reflection within the optical wave guide. Illustrated in FIG. 18A is an array 11 which employs a mirror back surface M and transmission mode LC controllable elements 22 (input) and 23 (output). Illustrated in FIG. 18B is an array 11 which employs a mirror front surface M and transmission mode LC controllable elements 22 (input) and 23 (output). The front mirror implementation provides greater manufacturing flexibility as mentioned hereinabove with respect to relaxed manufacturing tolerances and choice of materials.

It may be appreciated that various material compositions, various controllable material (e.g., LC, polymer, liquid, composite, etc.) layers, various electrodes, various director alignments, various geometrical forms, etc. can be used to fabricate the same device, which may provide “hidden” state for optical waves and very strong dielectric permittivity contrast for low frequency electric fields.

It is important to note that the while above-described embodiments of the proposed solution have been presented for illustration purposes, additional variants and modifications are possible and should not be excluded from the scope of the claims.

What is claimed is:

1. A beam projector device comprising a light source and a reflector for directing at least a part of a beam emitted from the light source, the reflector comprising a liquid crystal element that is electrically controllable to vary at least one of a beam shape and beam direction of said beam, wherein said device is further characterized by one of:
the liquid crystal element causing linear polarization of light and varying at least one of beam shape and beam direction of a first polarization of said beam, said reflector comprising a polarization transformer element so that the liquid crystal element varies at least one of beam shape and beam direction of a second polarization of said beam in reflection; and
the liquid crystal element varies beam shape of all polarizations of said beam.

2. A beam projector device as defined in claim 1, wherein said reflector further comprises a polarization transformer element.

3. A beam projector device as defined in claim 1 or 2, wherein said liquid crystal is of nematic type.

4. A beam projector device as defined in claim 1 or 2, wherein said liquid crystal further contains chiral molecules, polymers, nano and micro particles.

5. A beam projector device as defined in claim 1 or 2, wherein said liquid crystal is in the phase of cholesteric, blue, polymer stabilized, nano particle stabilized or polymer dispersed.

6. A beam projector device as defined in any one of claims 1 to 5, wherein said reflector is of planar disc shape.

7. A beam projector device as defined in any one of claims 1 to 5, wherein said reflector is of planar doughnut shape.

8. A beam projector device as defined in any one of claims 1 to 5, wherein said reflector is of bent shape.

9. A beam projector device as defined in any one of claims 1 to 8, wherein a diffractive or holographic element is included to enhance the steering or broadening as well as to perform other predetermined (recorded in the diffractive/holographic element) functions.

10. A beam projector device as defined in any one of claims 1 to 9, wherein the liquid crystal element is electrically controllable to vary only a beam shape.

11. A reflector for directing at least a part of a beam emitted from a light source, the reflector comprising a liquid crystal element that is electrically controllable to vary at least one of a beam shape and beam direction of said beam, wherein said reflector is further characterized by one of:
the liquid crystal element causing linear polarization of light and varying at least one of beam shape and beam direction of a first polarization of said beam, said reflector comprising a polarization transformer element so that the liquid crystal element varies at least one of beam shape and beam direction of a second polarization of said beam in reflection; and
the liquid crystal element varies beam shape of all polarizations of said beam.

12. A reflector as defined in claim 11, wherein said reflector further comprises a polarization transformer element.

13. A reflector as defined in claim 11 or 12, wherein said liquid crystal is of nematic type.

14. A reflector as defined in claim 11 or 13, wherein said liquid crystal further contains chiral molecules, polymers, nano and micro particles.

15. A reflector as defined in claim 11 or 13, wherein said liquid crystal is in the phase of cholesteric, blue, polymer stabilized, nano particle stabilized or polymer dispersed.

16. A reflector as defined in any one of claims 11 to 15, wherein said reflector is of planar disc shape.

17. A reflector as defined in any one of claims 11 to 15, wherein said reflector is of planar doughnut shape.

18. A reflector as defined in any one of claims 11 to 15, wherein said reflector is of bent shape.

19. A reflector as defined in any one of claims 11 to 18, wherein a diffractive or holographic element is included to enhance the steering or broadening as well as to perform other predetermined functions.
